(19) United States
(12) Patent Application Publication
(10) Pub. No.: US 2005/0117897 A1
(43) Pub. Date: Jun. 2, 2005

(54) Waterproof protector device

(75) Inventors: Koji Funahashi, Tokorozawa-shi (JP); Seiichi Ohira, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 10/994,734

(22) Filed: Nov. 22, 2004

(30) Foreign Application Priority Data
Nov. 28, 2003 (JP) 2003-400860

(51) Int. Cl. G03B 17/08

(52) U.S. Cl. 396/27

(57) ABSTRACT

A storage portion is provided in a body protector that has a waterproof space for storing a camera. A shoe cover that is removed from a hot shoe of the camera is put away into the storage portion. The storage portion is formed in a corner of the box-shaped waterproof space in the body protector. The shoe cover can be inserted into and removed from the storage portion in the optical axis direction of a camera lens.

### CROSS-REFERENCE TO RELATED APPLICATIONS

This application is based upon and claims the benefit of priority from prior Japanese Patent Application No. 2003-400860, filed Nov. 28, 2003; the entire contents of which are incorporated herein by reference.

### BACKGROUND OF THE INVENTION

1. Field of the Invention

This invention relates to a waterproof protector device capable of storing, for example, a digital camera.

2. Description of the Related Art

Conventionally, waterproof protectors have been used to protect cameras for underwater photography. One such waterproof protector is described in Jpn. Pat. Appln. KOKAI Publication No. 2002-90854. An ordinary waterproof protector comprises a body protector (front case) and a openable lid portion (rear case). The body protector has a waterproof space that houses the camera. The lid portion closes an opening of the body protector. The camera and the camera lens are housed in the waterproof protector.

There is also known a waterproof protector that is furnished with a relay connector for external strobe. When using an external strobe unit, a hot shoe connector is attached to a hot shoe of the camera in the protector. An inside contact pin of the relay connector is connected to the hot shoe connector. Outside the protector, a waterproof socket portion is connected to an outside contact pin of the relay connector. The socket portion is provided on a terminal end of a cord of the external strobe unit.

In this manner, the hot shoe of the camera and the external strobe unit are connected electrically to each other by means of the relay connector for external strobe. Thus, the external strobe unit glows when a release button of the camera is depressed. The “strobe” mentioned herein is synonymous with an electronic flash.

In some cases, the hot shoe may be fitted with a shoe cover that protects a contact portion and its surrounding region. The shoe cover is removed from the hot shoe when the relay connector for external strobe is used. A user must keep by his/her side the shoe cover that is removed from the camera. Since the shoe cover is a small part, however, it is liable to be lost if it is put in a clothing pocket or the like. Possibly, moreover, dust may adhere to the shoe cover if this is done.

If an electrically conductive substance, such as seawater, adheres to the shoe cover, in particular, it is supposed inevitably to cling to and corrode the contact portion of the hot shoe when the cover is attached to the shoe. It is strictly prohibited, therefore, to allow water (especially seawater) or other foreign matter to adhere to the shoe cover.

### BRIEF SUMMARY OF THE INVENTION

This invention has a feature that a waterproof protector device is capable of safely keeping camera parts, such as a shoe cover, removed from a camera.

A waterproof protector device according to the invention comprises a body protector which stores a camera and has therein a storage portion for storing a part to be stored. The stored part is an attachment part attachable to the camera or an attachment part attachable to a camera option for the camera, for example.

Those other parts than a shoe cover which are liable to be lost and easily affected by adhesion of water or other foreign matter may be also stored. These parts include, for example, recording media for recording images, a waterproof cap of a relay connector for external strobe, a protective cap of a connector of a synchronizing cord, a spare O-ring, etc. In short, a storage portion of a shape such that it can hold the part to be stored should only be formed on the inner surface of the body protector.

Since the camera is stored in the waterproof protector device, a user must care a great deal about water as he/she handles the protector device. In normal use, the waterproof protector device never allows penetration of water unless it is submerged. According to the present invention, the shoe cover or the like that is removed from the camera can be put away into the storage portion that is provided in a waterproof space in the protector device. Thus, water or foreign matter can be prevented from adhering to a part that is held in the storage portion, and besides, the part can be prevented from being lost.

Preferably, the body protector comprises a body portion which stores a camera body and a hinging lid portion which closes an opening of the body portion, the body portion or the lid portion being formed having the storage portion.

According to an aspect of the invention, the attachment part is a shoe cover attachable to an accessory shoe, such as a hot shoe of the camera, and the storage portion that stores the shoe cover is formed in a corner of a box-shaped waterproof space in the body protector.

According to another aspect of the invention, the storage portion has a shape such that the shoe cover can be moved for insertion and removal in the direction of an optical axis of a camera lens with the lid portion off. Alternatively, the storage portion has a shape such that the shoe cover can be moved for insertion and removal in a direction across the optical axis of the camera lens with the lid portion off. If the body portion of the body protector is formed of an integrally molded product of synthetic resin, the storage portion for holding the shoe cover should be molded integrally with the body portion.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view of a waterproof protector device according to a first embodiment of the invention;

FIG. 2 is a cross-sectional view of the waterproof protector device shown in FIG. 1;

FIG. 3 is a cross-sectional view of the waterproof protector device of FIG. 1 with its standard port off its body protector;

FIG. 4A is a side view of a part of the waterproof protector device of FIG. 1 with its buckle member in a locked position;

FIG. 4B is a side view of a part of the waterproof protector device of FIG. 1 with the buckle member in an unlocked position;

FIG. 5 is a rear view, partially in section, showing the waterproof protector device of FIG. 1;

FIG. 6 is a plan view of a hot shoe cover to be attached to a camera body shown in FIG. 5;

FIG. 7 is a front view showing an external strobe unit attached to the waterproof protector device of FIG. 1;

FIG. 8 is a rear view, partially in section, showing a hot shoe connector connected to a relay connector for external strobe shown in FIG. 5;

FIG. 9 is a cross-sectional view of a waterproof protector device according to a second embodiment of the invention; and

FIG. 10 is a rear view, partially in section, showing a waterproof protector device according to a third embodiment of the invention.

### DETAILED DESCRIPTION OF THE INVENTION

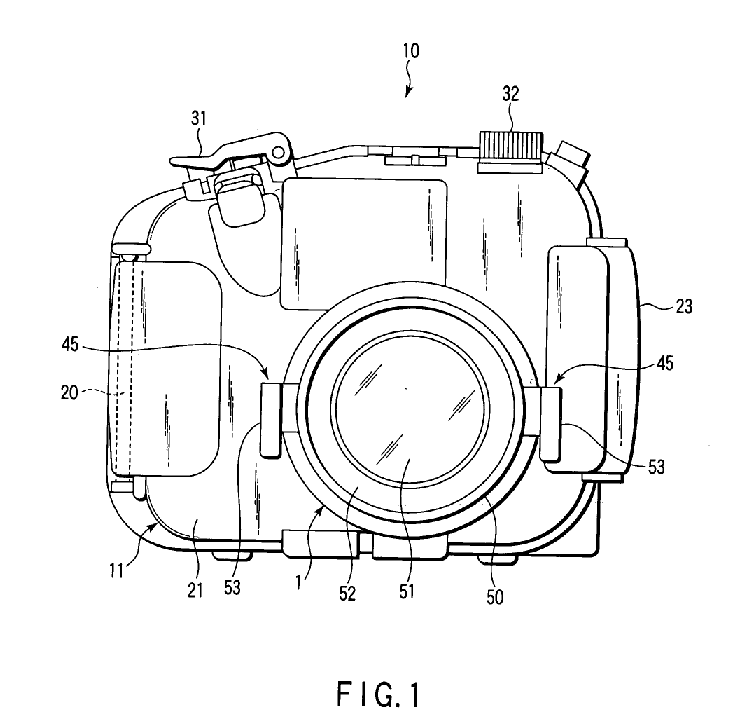

A first embodiment of the present invention will now be described with reference to FIGS. 1 to 8.

FIG. 1 is a front view of a waterproof protector device (waterproof case) 10 having a standard port 1. The protector device 10 comprises a body protector 11 (described below) and the standard port 1 that can be attached to and detached from the body protector 11.

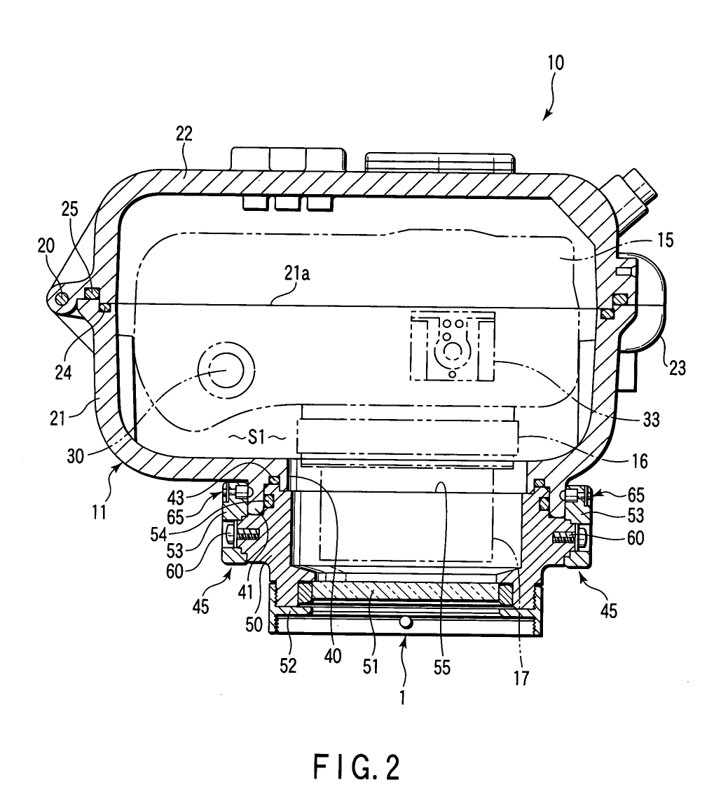

FIG. 2 is a cross-sectional view of the waterproof protector device 10 having the standard port 1. As shown in FIG. 2, a waterproof space S1 is defined in the body protector 11. The space S1 is surrounded by the protector 11 and the standard port 1. A camera body 15, such as a digital camera, is disposed for waterproofness in a predetermined position in the space S1.

The camera body 15 is provided with a frame 16. The frame 16 has an internal thread portion to which a filter or the like is to be attached. When a power switch (not shown) of the camera body 15 is turned on, a camera lens 17 projects forward from a collapsed state in which it is retracted in the body 15. More specifically, the camera lens 17 as a moving part projects forward or toward a subject from the inside diameter side of the frame 16, as shown in FIG. 2. The camera body 15 and the camera lens 17 constitute a camera according to this invention.

When the power switch of the camera body 15 is turned on, as described above, the camera lens 17 moves from the position in which it is collapsed in the camera body 15 to a standby state for photographing (projected position). The standard port 1 has a function to secure a waterproof space for the camera lens 17 that moves in this manner.

The body protector 11 is provided with a body portion 21 and a lid portion 22. The lid portion 22 is rockably coupled to the body portion 21 by a hinge shaft 20 shown in FIG. 2. The camera body 15 is housed in a waterproof space that is defined inside the lid portion 22 and the body portion 21. The lid portion 22 is swingably mounted on the body portion 21 so that it can close an opening 21a of the body portion 21. If the lid portion 22 is swung open, the opening 21a of the body portion 21 is opened.

The body portion 21 and the lid portion 22 are each formed of a molded product of synthetic resin (e.g., polycarbonate) that is impermeable to water and highly resistant to pressure. The body portion 21 and the lid portion 22 can be held in a closed state by a clamp mechanism 23. Waterproof seal members 24 and 25, such as O-rings, are arranged in joint portions of the body portion 21 and the lid portion 22, respectively.

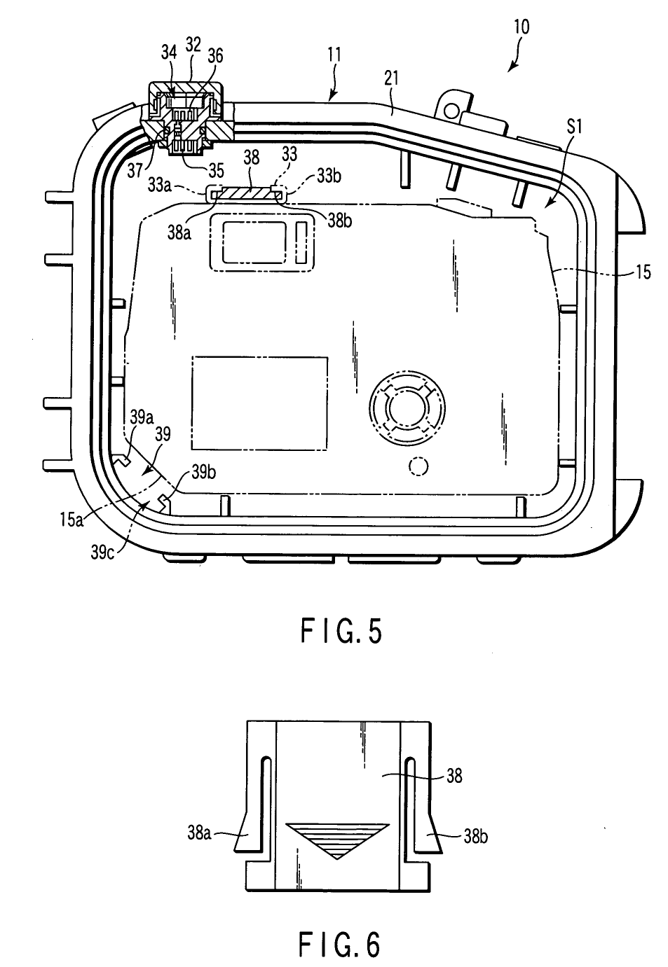

The body portion 21 of the body protector 11 is provided with an operating member 31 (shown in FIG. 1). The operating member 31 is used to operate a release button 30 (shown in FIG. 2 and other drawings) of the camera body 15. Further, the body protector 11 is fitted with various necessary operating members for the manipulation of the camera body 15, a cap 32 that covers a relay connector 34 (shown in FIG. 5) for external strobe, etc.

As shown in FIG. 5, the relay connector 34 for external strobe is provided on the body portion 21 of the body protector 11. The connector 34 has contact pins 35 and 36 that project inside and outside, respectively, of the protector 11. The space between the connector 34 and the protector 11 is sealed by a waterproof seal member 37, such as an O-ring.

The camera body 15 is provided with a hot shoe 33 that is used for strobe-synchronous luminescence and the like. The hot shoe 33 is a kind of accessory shoe. It is provided with an electrical contact portion, such as a trigger contact for strobe. When the hot shoe 33 need not be used, a shoe cover 38 which is an example of a stored part (indicated by hatching in FIG. 5) is attached to it to protect the contact portion and its surrounding region. The shoe cover 38 is an example of an attachment part that can be attached to the camera body 15.

FIG. 6 shows an example of the shoe cover 38. The shoe cover 38 has a pair of side portions 38a and 38b. The side portions 38a and 38b can be fitted individually in opposite side portions 33a and 33b of the hot shoe 33. The shoe cover 38 can be inserted into and removed from the hot shoe 33 in the optical axis direction of the camera lens 17 of the camera body 15.

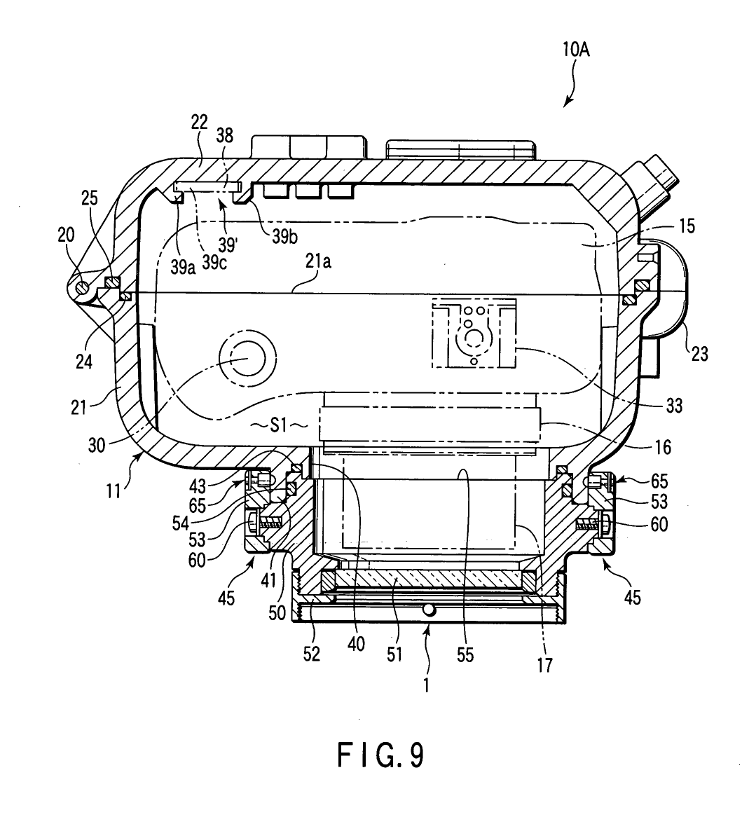

A storage portion 39 for storing the shoe cover 38 removed from the camera is provided in the body protector 11. The storage portion 39 is formed in one lower corner of the box-shaped waterproof space S1 in the protector 11. More specifically, the storage portion 39 is formed extending along a slanting corner portion 15a at the bottom of the camera body 15 so that it is inclined vertically. If there is any spatial allowance on the side of the lid portion 22, the lid portion may alternatively be provided with a storage portion 39′, as in a second embodiment (FIG. 9), which will be mentioned later.

As shown in FIG. 5, the storage portion 39 has a pair of retaining walls 39a and 39b. The walls 39a and 39b are formed in positions corresponding individually to the side portions 38a and 38b of the shoe cover 38. A recess 39c is defined between the walls 39a and 39b. When the lid portion 22 is off, the shoe cover 38 can be moved for insertion and removal with respect to the recess 39c in the optical axis direction of the camera lens 17. By way of example, the retaining walls 39a and 39b of the storage portion 39 are molded integrally with the body portion 21 of the body protector 11 that is formed of an integrally molded product of synthetic resin.

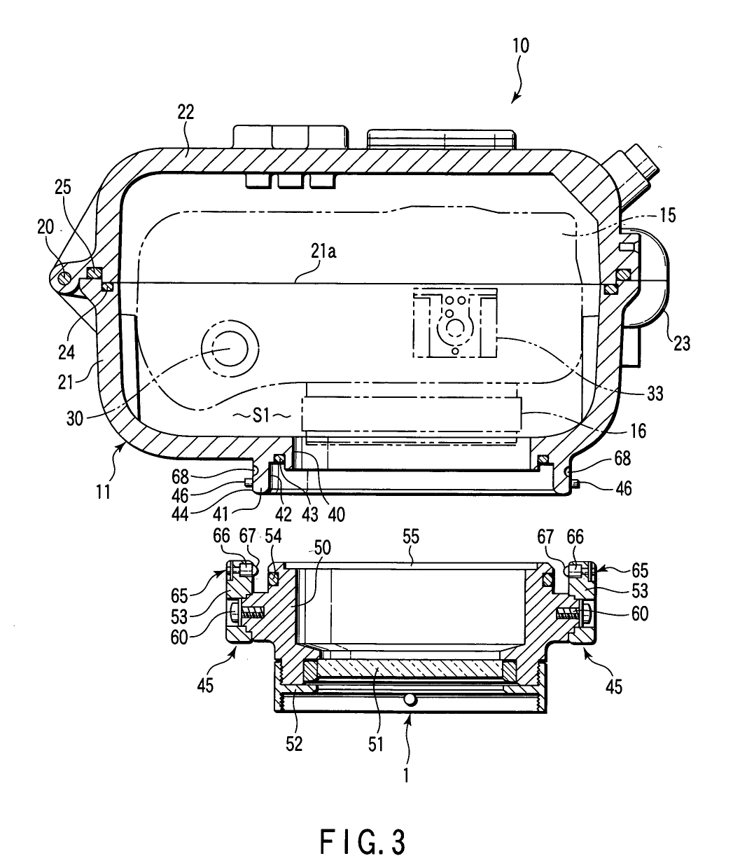

An opening 40 (shown in FIG. 3) is formed in the body portion 21 of the body protector 11. The opening 40 is formed in a region corresponding to the front face of the frame 16 of the camera body 15. The inside diameter of the opening 40 is a little larger than the diameter of the frame 16 and is large enough to allow the insertion of the camera lens 17 at the least.

A first opening portion 41 in the shape of a short cylinder is formed around the opening 40 on the outer surface of the body protector 11. The first opening portion 41 is larger in diameter than and concentric with the opening 40. An inner peripheral surface 42 of the first opening portion 41 forms a seal surface with which a seal member 54 is intimately in contact. To attain this, the inner peripheral surface 42 is finished smooth. An O-ring 43 that serves as a waterproof seal member is interposed between the opening 40 and the first opening portion 41. As shown in FIG. 3, a pair of protrusions 46 are formed on an outer peripheral surface 44 of the first opening portion 41. Each of the protrusions 46 forms a part of a buckle mechanism 45.

The standard port 1 is provided with a substantially cylindrical barrel portion 50, a light transmitting portion 51 formed of a transparent material such as glass, a hood member 52, a pair of buckle members 53, and a seal member 54 such as an O-ring. The light transmitting portion 51 is provided on the front end portion of the barrel portion 50. An opening portion 55 at the rear end of the barrel portion 50 can be fitted in the first opening portion 41. If necessary, the hood member 52 is attached to the barrel portion 50. The buckle members 53 are provided individually on the opposite side portions of the barrel portion 50. The seal member 54 is disposed on the rear end portion of the barrel portion 50 or that part thereof (second opening portion) which is inserted in the first opening portion 41. It can be brought intimately into contact with the inner peripheral surface 42 of the first opening portion 41.

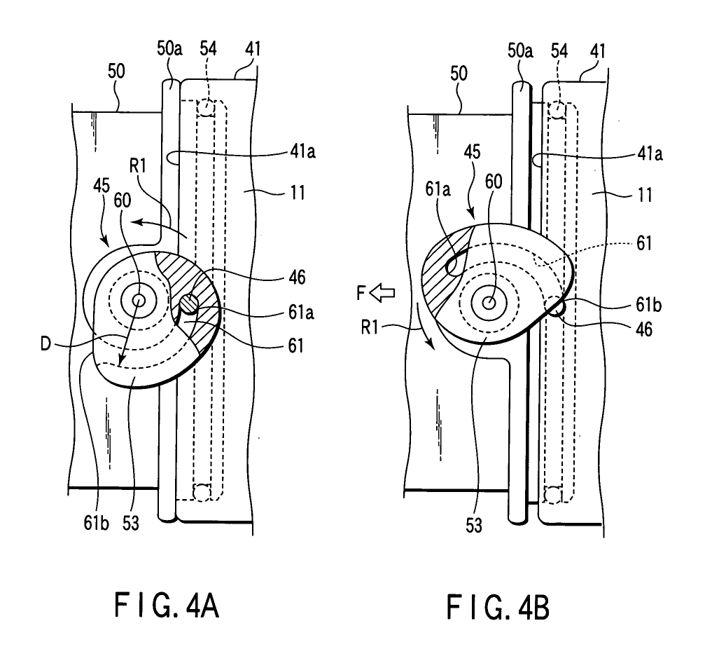

The buckle members 53 and the protrusions 46 constitute the buckle mechanisms 45. The buckle members 53 can rock individually around shafts 60 between a locked position shown in FIG. 4A and an unlocked position shown in FIG. 4B. They may alternatively be designed to be further rockable in the direction of arrow R1 from the position shown in FIG. 4B.

As shown in FIGS. 4A and 4B, a cam groove 61 is formed on the inner surface side of each buckle member 53. The cam groove 61 has a spiral shape such that a distance D from the shaft 60 gradually increases from its one end 61a toward its other end 61b. When each buckle member 53 is rocked to the locked position shown in FIG. 4A, each protrusion 46 gets fitted in a region on the side of the one end 61a of the cam groove 61. Thus, a flange portion 50a of the barrel portion 50 of the standard port 1 is pressed in a direction such that it abuts against a front end face 41a of the first opening portion 41. At the same time, the standard port 1 is fixed to the body protector 11.

If each buckle member 53 is rocked in the direction (unlocking direction) indicated by arrow R1 in FIG. 4A, the cam groove 61 moves sliding relatively to the protrusion 46 in the direction of arrow R1. Thereupon, the flange portion 50a of the barrel portion 50 is slightly pushed out in a direction (indicated by arrow F) such that it moves away from the front end face 41a of the first opening portion 41, as shown in FIG. 4B. When the buckle member 53 reaches the unlocked position shown in FIG. 4B, the protrusion 46 is disengaged from the cam groove 61. Thereupon, the standard port 1 is allowed to be removed from the body protector 11. In attaching the port 1 to the protector 11, the buckle member 53 is rocked in the direction opposite to the unlocking direction R1. By doing this, the port 1 is fixed to the protector 11.

As shown in FIGS. 2 and 3, each buckle member 53 is provided with a detent mechanism (click means) 65. The detent mechanism 65 includes a retaining member 67. The retaining member 67 is urged by a spring portion 66 to project from the inside of the buckle member 53. The body protector 11 is formed having recesses 68 in which the retaining members 67 can be fitted individually. The recesses 68 are situated so that they engage their corresponding retaining members 67 when the buckle members 53 are moved to the locked position.

When the buckle members 53 are moved to the locked position, the retaining members 67 engage their corresponding recesses 68. If this is done, the positions of the buckle members 53 are settled, and a so-called click feeling is produced. Thus, the arrival of the buckle members 53 at the locked position can be noticed.

The following is a description of the operation of the waterproof protector device 10 according to the present embodiment.

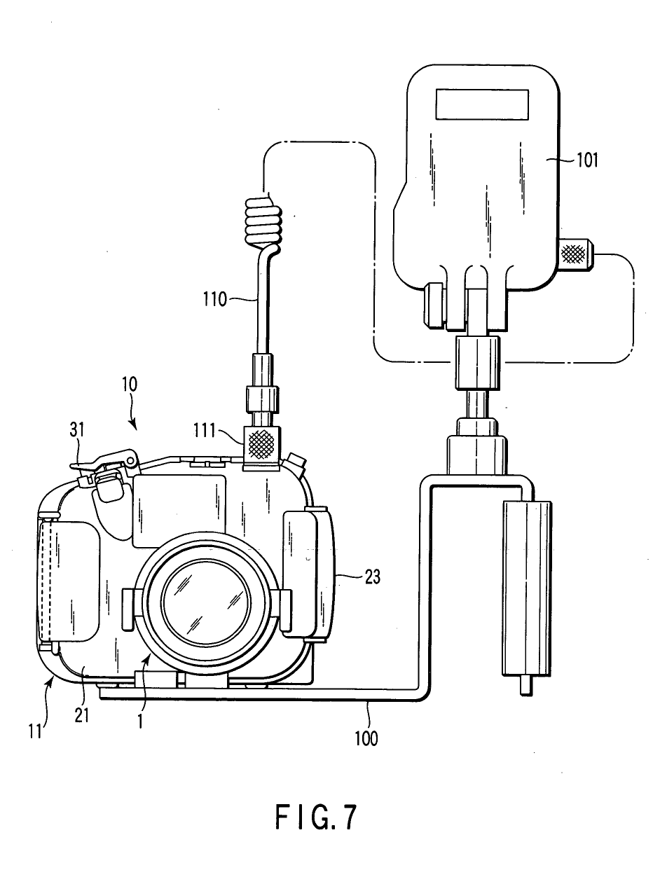

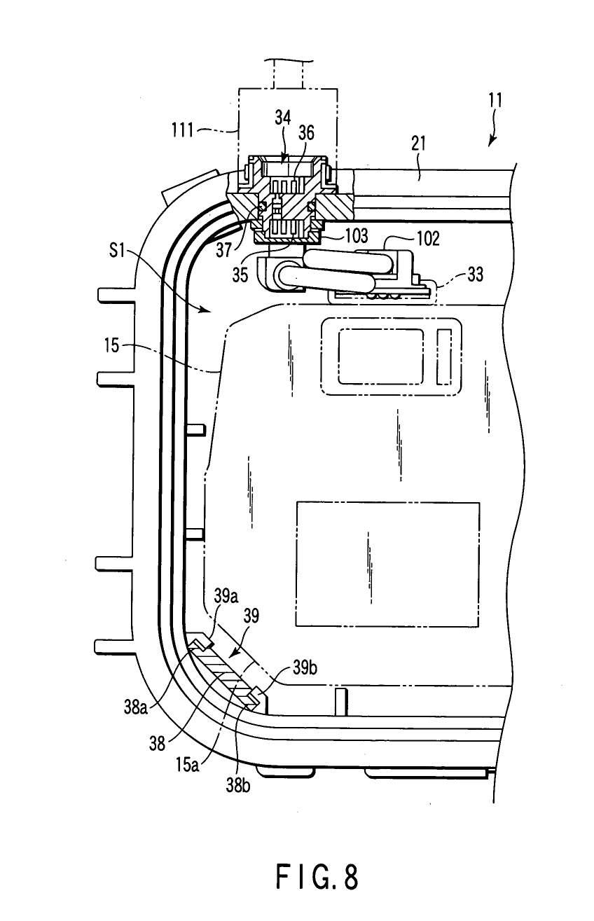

FIG. 7 shows an external strobe unit 101 as an example of a camera option. The waterproof protector device 10 can be fitted with the strobe unit 101 by means of a bracket 100 that is attached to the body protector 11. In this case, the shoe cover 38 is removed from the hot shoe 33. Then, the shoe cover 38 is put away into the storage portion 39 of the body protector 11, as shown in FIG. 8.

In the body protector 11, a hot shoe connector 102 is attached to the hot shoe 33 of the camera body 15. Further, a socket portion 103 of the connector 102 is connected mechanically and electrically to the inside contact pin 35 of the relay connector 34 for external strobe.

Outside the body protector 11, the waterproof cap 32 is removed from the relay connector 34 for external strobe. Then, a waterproof socket portion 111 is connected to the outside contact pin 36 of the connector 34. The socket portion 111 is provided on a terminal end of a synchronizing cord 110 of the external strobe unit 101.

As this is done, the hot shoe 33 of the camera body 15 and the external strobe unit 101 are connected electrically to each other by the relay connector 34 for external strobe. Thus, the strobe unit 101 can glow when the release button 30 of the camera body 15 is depressed.

According to the waterproof protector device 10 of the present embodiment, the shoe cover 38 that is removed from the camera body 15 can be put away into the storage portion 39. Thus, the shoe cover 38 can be inserted into or removed from the storage portion 39 if the lid portion 22 is swung open. The storage portion 39 is located in the waterproof space S1 in the waterproof protector device 10. When the lid portion 22 is on, therefore, water or foreign matter can be prevented from adhering to the shoe cover 38 that is held in the storage portion 39. Also, the shoe cover 38 can be prevented from being lost.

FIG. 9 shows a waterproof protector device 10A according to a second embodiment of the invention. In this protector device 10A, a storage portion 39′, which is constructed in the same manner as the one according to the first embodiment, is provided on the inner surface of a lid portion 22. A pair of retaining walls 39a and 39b of the storage portion 39′ are molded integrally with the lid portion 22 that is formed of an integrally molded product of synthetic resin. If the lid portion 22 is swung open, the shoe cover 38 can be inserted into or removed from a recess 39c between the walls 39a and 39b in a direction across the optical axis of the camera lens 17. The waterproof protector device 10A shares other configurations with the waterproof protector device 10 of the first embodiment. Therefore, common numerals are used to designate common portions of the two embodiments, and a description of those portions is omitted.

Another storage portion may be provided for storing those other attachment parts than the shoe cover 38 which are liable to be lost and easily affected by adhesion of water or other foreign matter. These parts include, for example, recording media (plate- or stick-shaped media) for recording images, a waterproof cap 32 of a relay connector 34 for external strobe, a protective cap attached to a socket portion 111 of a synchronizing cord 110, a spare O-ring, etc. In short, a storage portion of a shape such that it can hold the attachment parts should only be formed on the inner surface of the body portion 21 or the lid portion 22 of the body protector 11.

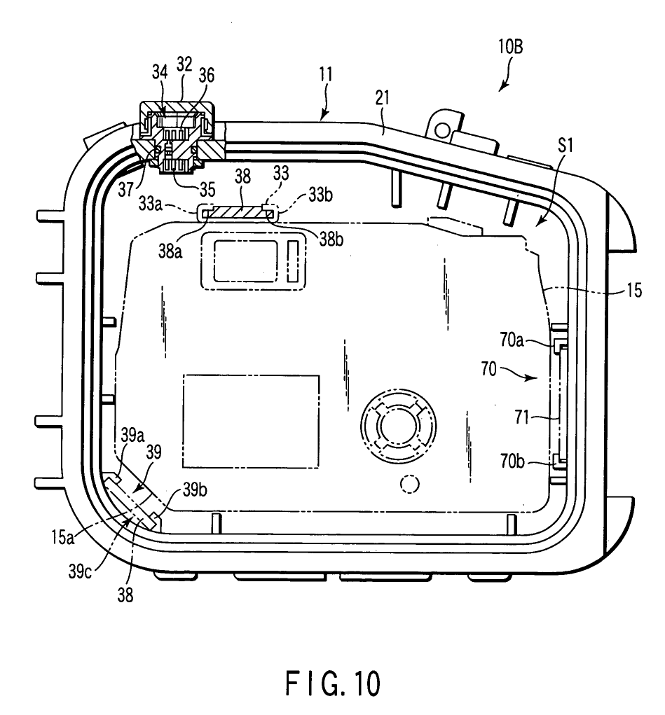

FIG. 10 shows a waterproof protector device 10B according to a third embodiment of the invention. In this protector device 10B, a storage portion 70 for holding a memory card 71 is provided on the inner surface of a body portion 21 of a body protector 11. The memory card 71 is an example of a recording medium that is used in the camera body 15. When the camera is used, the card 71 is inserted into a card storage portion of the camera body 15. Photographed images and the like are recorded in the card 71.

The storage portion 70 has a pair of retaining walls 70a and 70b. The walls 70a and 70b are molded integrally with the body portion 21. When a lid portion 22 is off, the memory card 71 can be moved for insertion and removal between the retaining walls 70a and 70b in the optical axis direction of the camera lens 17 (shown in FIG. 2).

Water or other foreign matter can be prevented from adhering to the memory card 71 in the storage portion 70 by closing the lid portion 22. Also, the card 71 can be prevented from being lost. With use of the waterproof protector device 10B that has the storage portion 70 constructed in this manner, a spare memory card 71 can be safely stored in a waterproof space S1 in the body protector 11, besides the memory card stored in the camera body 15. The waterproof protector device 10B shares other configurations with the waterproof protector device 10 of the first embodiment. Therefore, common numerals are used to designate common portions of the first and third embodiments, and a description of those portions is omitted. The storage portion 70 may alternatively be provided on the inner surface of the lid portion 22 of the body protector 11.

It is to be understood, in carrying out the present invention, that the components of the invention, including the storage portion and the body protector that constitute the waterproof protector device, may be variously changed or modified without departing from the scope or spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A waterproof protector device which stores a camera, comprising a body protector which stores the camera and has therein a storage portion for storing a part to be stored.

2. A waterproof protector device according to claim 1, wherein the stored part is an attachment part attachable to the camera.

3. A waterproof protector device according to claim 1, wherein the stored part is an attachment part attachable to a camera option for the camera.

4. A waterproof protector device according to claim 1, wherein the body protector comprises a body portion which stores a camera body and a hinging lid portion which closes an opening of the body portion, the body portion being formed having the storage portion.

5. A waterproof protector device according to claim 1, wherein the body protector comprises a body portion which stores a camera body and a hinging lid portion which closes an opening of the body portion, the lid portion being formed having the storage portion.

6. A waterproof protector device according to claim 4, wherein the storage portion has a shape such that a shoe cover for the camera can be moved for insertion and removal in the direction of an optical axis of a camera lens of the camera with the lid portion off.

7. A waterproof protector device according to claim 5, wherein the storage portion has a shape such that a shoe cover for the camera can be moved for insertion and removal in a direction across an optical axis of a camera lens of the camera with the lid portion off.

8. A waterproof protector device according to claim 4, wherein the body portion of the body protector is formed of an integrally molded product of synthetic resin, and the storage portion for holding a shoe cover for the camera is molded integrally with the body portion.

9. A waterproof protector device according to claim 5, wherein the lid portion of the body protector is formed of an integrally molded product of synthetic resin, and the storage portion for holding a shoe cover for the camera is molded integrally with the lid portion.
